(19) United States
(12) Patent Application Publication
(10) Pub. No.: US 2019/0050833 A1
(43) Pub. Date: Feb. 14, 2019

(54) Systems and Methods for Distributing Data to Node Devices for Real Time Scoring, Based on Accounts for the Data

(71) Applicant: MASTERCARD INTERNATIONAL INCORPORATED, Purchase, NY (US)

(72) Inventors: Po Hu, Norwalk, CT (US); Jean-Pierre Gerard, Croton-On-Hudson, NY (US)

(21) Appl. No.: 15/671,543

(22) Filed: Aug. 8, 2017

(51) Int. Cl. G06Q 20/10; H04L 29/08

(52) U.S. Cl. CPC G06Q 20/10; H04L 67/1097

(57) ABSTRACT

Systems and methods are provided for use in scoring network data related to an account. An example method includes locating, by a node device, in response to a trigger event, a tree node for an account in a B-tree data structure where the tree node includes at least one network address in a data array, and retrieving, by the node device, network data associated with the at least one network address from the data array. The method also includes transmitting, by the node device, the network data to at least one computing device, and then generating and publishing, at the at least one computing device, at least one score based on a historical model and the retrieved network data in real time or near real time, thereby permitting services based on the at least one score to be offered to a consumer associated with the account.

### FIELD

The present disclosure generally relates to systems and methods for use in distributing account data to permit real time (or near real time) scoring of the data, and in particular, to systems and methods for distributing network transaction data to nodes, per account, and processing the data according to desired models, per account, in real time (or near real time), thereby allowing and/or providing the real time (or near real time) scoring of the data for the accounts for services associated with the accounts.

### BACKGROUND

This section provides background information related to the present disclosure which is not necessarily prior art.

Payment accounts are used by consumers to perform numerous different transactions including, for example, purchasing products (e.g., goods and/or services) from merchants, etc. In connection with the transactions, entities such as, for example, issuers of the payment accounts, etc., gather transaction data for the transactions and store the same for use in modeling the accounts for purposes of marketing, fraud prevention and other services. The transaction data is often stored within payment networks that facilitate the transactions, for example, and is generally distributed across the networks to available storage locations and is un-indexed according to the payment accounts to which it relates. After the transaction data is stored, models may be compiled to predict, for example, likelihoods that consumers will purchase certain products, or will purchase from certain merchants. The models are generated based on batches of the transaction data, associated with multiple different consumers and/or accounts. And, as additional transaction data is gathered, and provided in such batches, the models are updated and/or corresponding scorings for the accounts and/or consumers are updated, from which various services may or may not be identified for offer to the consumers.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in distributing account data to particular nodes, per payment account, to permit real time (or near real time) scoring of the data;

FIG. 2 is a block diagram of an exemplary computing device that may be used in the system of FIG. 1; and

FIG. 3 is an exemplary method, which may be implemented via the system of FIG. 1, for distributing the account data to the particular nodes to permit real time (or near real time) scoring of the data.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Payment accounts are often used to fund transactions at merchants for the purchase of products (e.g., goods and/or services). Typically, transaction data (broadly, account data) for the transactions is stored within payment networks that facilitate/process the transactions and is used to compile models, whereby predictor variables can be identified for different conditions or variables associated with the transactions or with potential future transactions. Typically, the models and their use are based on batch files of the transaction data, representing multiple transactions grouped together at a time after the transaction data is actually compiled and/or stored. Uniquely, the systems and methods herein provide for real time (or near real time) analysis of transaction data, for specific consumers, to provide more accurate (and more timely) prediction scores for the specific consumers. In particular herein, transaction data is segregated and stored into allocated blocks of memory (e.g., in random access memory (RAM), etc.) (broadly, transaction arrays or data arrays) in node devices within a payment network, as transactions are performed, whereupon the transaction data may be accessed efficiently upon addition of new transaction data (or upon another trigger event) to determine and/or update a prediction score associated with a specific consumer. As such, scoring of the consumer via the prediction score may be more responsive and inclusive of more recent transactions performed by the consumer. And, services dependent on such scoring of the consumer for providing marketing, offers based on predicted behavior, fraud prevention measures, etc. can be implemented more rapidly, as new transactions are performed (i.e., in real time or near real time).

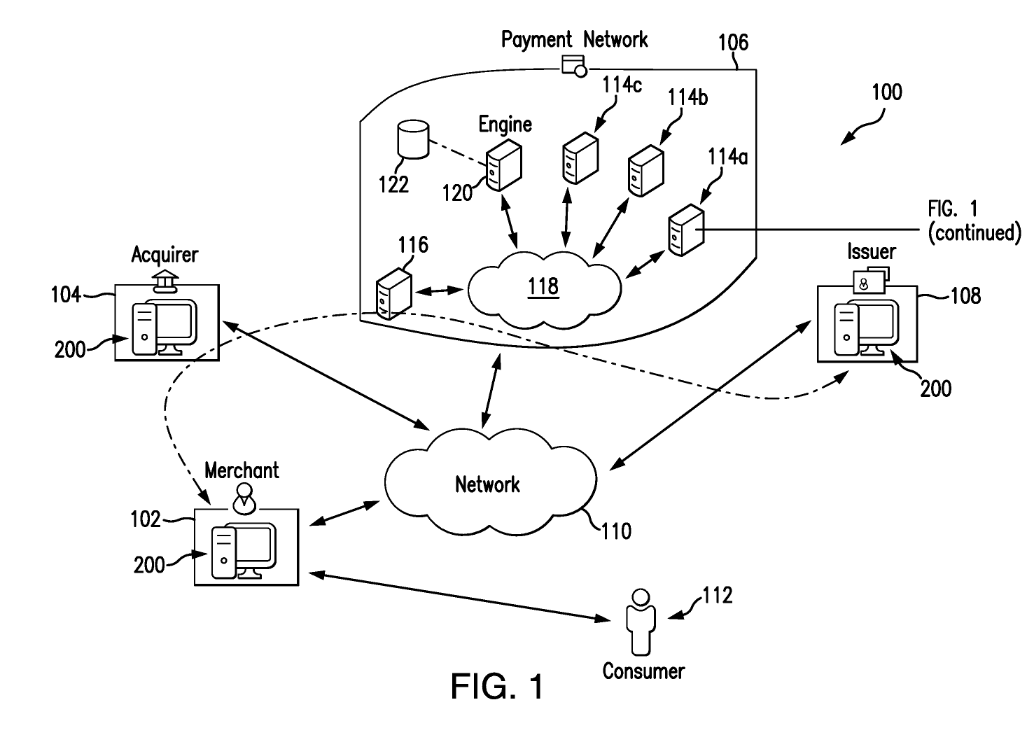

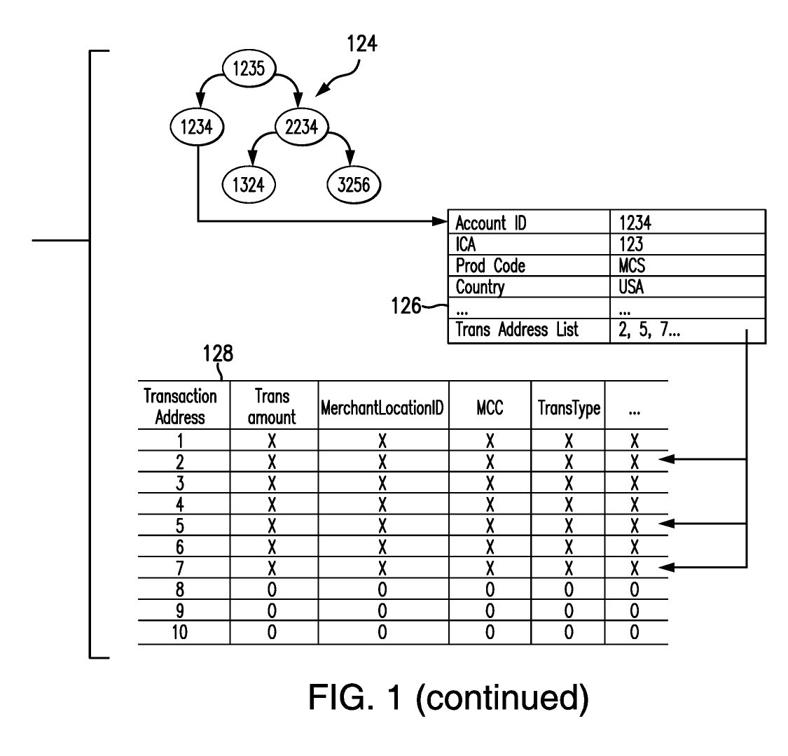

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise depending on, for example, services offered and/or prediction scores determined in the system 100, etc.

As shown in FIG. 1, the illustrated system 100 generally includes a merchant 102, an acquirer 104 associated with the merchant 102, a payment network 106, and an issuer 108 configured to issue payment accounts to consumers, each coupled to (and in communication with) a network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In particular, in this example, the acquirer 104, the payment network 106, and the issuer 108 may be connected via a private payment transaction network that is part of network 110 for processing payment account transactions, and the merchant 102 may be connected with consumers to facilitate payment account transactions, for example, through a public network, such as the Internet, that is also part of network 110.

In this exemplary embodiment, the merchant 102 is configured to offer and to sell products (e.g., goods, services, etc.) to consumers, including, for example, consumer 112. The merchant 102 may be disposed at a physical location (e.g., a brick-and-mortar location, etc.) and/or may be accessible through a virtual location (e.g., a network-based application (e.g., a website, etc.), etc.). The acquirer 104 is a financial institution (e.g., a bank, etc.) associated with the merchant 102. The acquirer 104 issues an account, for the merchant 102, through which the merchant 102 is able to receive and/or deposit, or withdraw, funds related to transactions, including, specifically, payment account transactions involving consumer 112 (and other consumers). The issuer 108 is also a financial institution (e.g., a bank, etc.), which issues accounts to consumers (e.g., payment accounts, etc.), including the consumer 112, through which the consumers may pay funds to the merchant 102 (or other merchants) for the purchase of one or more products. For purposes of explanation herein, the consumer 112 is issued an account, by the issuer 108, and the account number (e.g., primary account number (PAN), etc.) associated with the account is 1234-1234-1234-1234.

In one exemplary transaction, in view of the above, the consumer 112 may seek to purchase a product from the merchant 102, using his/her payment account issued by the issuer 108 to fund the purchase. In so doing, the consumer 112 presents to the merchant 102 a payment device associated with his/her payment account (e.g., a debit card, a credit card, a fob, a payment-enabled communication device, etc.). In connection therewith, the merchant 102 is configured to receive and/or retrieve credentials for the consumer's payment account from the payment device, for example, via a point-of-sale (POS) terminal, and to communicate an authorization request for the purchase to the acquirer 104, through the network 110 (along path A in FIG. 1). In turn, the acquirer 104 is configured to communicate with the issuer 108, through the payment network 106 (again via the network 110), for authorization of the transaction (e.g., to determine if the consumer's payment account is in good standing and if there is/are sufficient credit/funds to complete the transaction, etc.). If the issuer 108 accepts the transaction, the issuer 108 is configured to provide an authorization reply back to the merchant 102 (again, generally along path A) approving the transaction, and the merchant 102 is then able to proceed in the transaction. The transaction is later cleared and settled by and between the merchant 102 and the acquirer 104 and by and between the acquirer 104, the payment network 106, and the issuer 108 (in accordance with settlement arrangements, etc.). Conversely, if the issuer 108 declines the transaction, the issuer 108 is configured to provide an authorization reply back to the merchant 102 declining the transaction, and the merchant 102 is able to terminate the transaction with the consumer 112, or request an alternate form of funding.

In the exemplary embodiment, the payment network 106 is configured to perform a variety of services related to payment account transactions, including for the example transaction above (e.g., marketing services, product offer services, reward services, fraud detection/prevention services, etc.). As shown, in connection with providing such services, the payment network 106 includes multiple node devices 114a-c and an edge device 116. The node devices 114a-c and the edge device 116 generally form and/or are coupled to (and are in communication with) a network 118 within the payment network 106 (similar to network 110). As such, each of the node devices 114a-c and the edge device 116 are coupled to one another and/or are able to communicate with one another, directly or indirectly, via the network 118. Further, the edge device 116 is disposed, generally, at the “edge” of the payment network 106, such that the edge device 116 communicates and/or is coupled to other entities or partners of the payment network 106, such as, for example, the acquirer 104 and the issuer 108, etc. In the above exemplary transaction between the merchant 102 and the consumer 112, the authorization request for the transaction is received by the payment network 106 from the acquirer 104 at the edge device 116, and is sent by the payment network 106 to the issuer 108 via the edge device 116. It should, of course, be appreciated that in various embodiments, numerous edge devices, consistent with edge device 116, will be included in the payment network 106 (e.g., tens, hundreds, thousands, etc.).

In this exemplary embodiment, the node devices 114a-c are generally internal to the payment network 106 and are configured to store, as described below, transaction data and to perform the various services associated with the transaction data on behalf of the payment network 106, among other things.

With that said, as used herein, transaction data may include data generated, collected, and stored as part of the above-described interactions between the consumer 112, the merchant 102, the acquirer 104, the payment network 106, and the issuer 108. In particular, transaction may include, without limitation, payment account numbers, amounts of transactions, merchant IDs, merchant category codes (MCCs), region codes for the merchant 102 (or other merchants) involved in transactions and/or for POS terminals associated with the merchants (or other merchant location identifiers and/or transaction location identifiers), merchant DBA names, dates/times of transactions, products purchased and related descriptions or identifiers, etc. It should be appreciated that more or less information related to transactions, as part of either authentication of consumers, authorization and/or clearing and/or settling, etc., may be included in transaction data and stored within the system 100, at the merchant 102, the acquirer 104, the payment network 106 (e.g., at the node devices 114a-c and/or the edge device 116, etc.), and/or the issuer 108.

It should also be appreciated that consumers involved in the transactions herein, including the consumer 112, and/or the merchants herein, including the merchant 102, are prompted to agree to legal terms associated with their payment accounts, for example, during enrollment in their accounts, etc. In so doing, the consumers and also the merchants may voluntarily agree, for example, to allow certain entities to use data collected during enrollment and/or collected in connection with processing transactions associated with the payment accounts, subsequently, for one or more of the different purposes described herein.

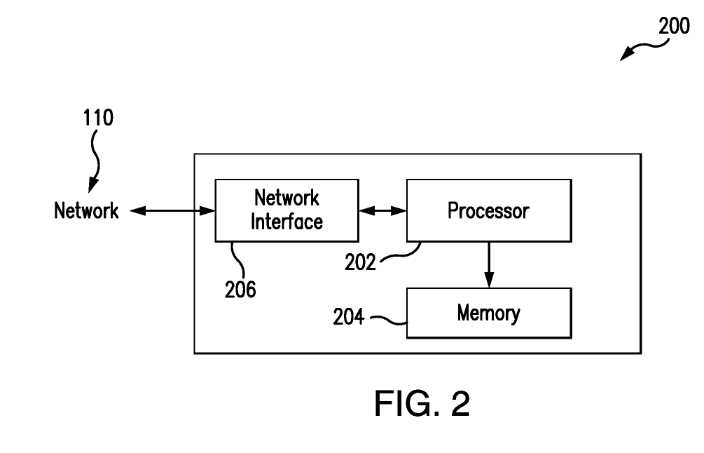

FIG. 2 illustrates an exemplary computing device 200 that can be used in the system 100. The computing device 200 may include, for example, one or more servers, network nodes, workstations, computers, laptops, tablets, smartphones, POS terminals, other suitable computing devices, etc. In addition, the computing device 200 may include a single computing device, or it may include multiple computing devices located in close proximity, or multiple computing devices distributed over a geographic region, so long as the computing devices are specifically configured to function as described herein. In the system 100, each of the merchant 102, the acquirer 104, and the issuer 108 are illustrated as including, or being implemented in, computing device 200, coupled to the network 110. In addition, the payment network 106 may include one or more computing devices consistent with computing device 200. In particular, for example, the node devices 114a-c and the edge device 116 of the payment network 106 may each be considered a computing device consistent with computing device 200. However, the system 100 should not be considered to be limited to the computing device 200, as described below, as different computing devices and/or arrangements of computing devices may be used.

Referring to FIG. 2, the exemplary computing device 200 generally includes a processor 202 and a memory 204 coupled to (and in communication with) the processor 202. The processor 202 may include one or more processing units (e.g., in a multi-core configuration, etc.) including, without limitation, a central processing unit (CPU) and/or multi-core CPUs, a microcontroller, a reduced instruction set computer (RISC) processor, an application specific integrated circuit (ASIC), a programmable logic device (PLD), a gate array, and/or any other circuit or processor capable of the functions described herein. The above examples are exemplary only, and are not intended to limit in any way the definition and/or meaning of processor.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices (e.g., solid state drives (SSDs), etc.), flash drives, CD-ROMs, thumb drives, floppy disks, tapes, hard disks, and/or any other type of volatile or nonvolatile physical or tangible computer-readable media. The memory 204, and/or data structures included therein, may be configured to store, without limitation, transaction data, account indexes, other data relating to the merchant 102 and/or the consumer 112 (or his/her account) (and other merchants and/or consumers), and/or other types of data and/or information suitable for use as described herein. Specifically, and as will be explained in more detail below, the node devices 114a-c and/or the edge device 116 are configured to store transaction data in RAM memory 204, in a particular manner, which enables the operations described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. It should be appreciated that the memory 204 may include a variety of different memories, each implemented in one or more of the functions or processes described herein.

In addition, the illustrated computing device 200 also includes a network interface 206 coupled to (and in communication with) the processor 202 and the memory 204. The network interface 206 may include, without limitation, a wired network adapter, a wireless network adapter, a mobile network adapter, or other device capable of communicating with one or more different networks, including the network 110. Further, in some exemplary embodiments, the computing device 200 includes the processor 202 and one or more network interfaces incorporated into or with the processor 202.

Referring again to FIG. 1, the node devices 114a-c and the edge device 116 of the payment network 106 are configured to cooperate, in order to store transaction data, in a manner that permits efficient retrieval and/or processing of such data consistent with one or more services provided by the payment network 106 (or otherwise), etc.

In particular, the edge device 116 is configured to receive transaction data (e.g., from the acquirer 104 as part of an authorization request, from the issuer 108 as part of an authorization reply, or otherwise; etc.) and to identify one of the node devices 114a-c in which the transaction data is to be stored. In one example, the edge device 116 is configured to identify the one of the node devices 114a-c based on the account number involved in the particular transaction data, or based on a part thereof such as, for example, the last three, five, or six, etc. digits, etc. Specifically, the edge device 116 is configured to divide the account number, or part thereof, by a number, which is indicative of the number of node devices 114a-c at which the transaction data may be stored. For example, where there are the three node devices 114a-c, as in FIG. 1, the edge device 116 is configured to divide the account number, or part thereof (e.g., the last four digits, etc.), by “3,” whereupon the residual (or remainder) of the division is either 0, 1, or 2. The edge device 116 is then configured to identify the node device 114a when the residual is “1,” to identify the node device 114b when the residual is “2,” and to identify the node device 114c when the residual is “0.” It should be appreciated that the edge device 116 may be configured otherwise, in other system embodiments, to distribute the transaction data, for example, based on account numbers, or otherwise in similar or different manners.

It should further be appreciated that by configuring the edge device 116, as described above, only one of the node devices 114a-c will be identified for transaction data associated with a particular account.

Then in the system 100, in this example, when the node device 114a is identified (i.e., when 1234 (which are the last four digits of the consumer's payment account number used in the above transaction) is divided by 3 to provide a residual of “1”), the edge device 116 is configured to provide the transaction data for the given transaction to the identified node device 114a.

In this exemplary embodiment, each of the node devices 114a-c is configured to store transaction data in a data structure(s) in RAM memory (e.g., in memory 204, etc.). Specifically, each of the node devices 114a-c includes a B-tree data structure having multiple nodes and having a transaction array (or data array). In connection therewith, the B-tree data structure of each of the node devices 114a-c is generally balanced to facilitate searching in an efficient manner. For example, for a B-tree data structure comprising N tree nodes (or keys), the time (e.g., the potentially required number of searches, etc.) to search the B-tree data structure may be log₂ N. In particular, for a B-tree data structure comprising one million tree nodes, a node device comprising the B-tree data structure (e.g., like one of the node devices 114a-c, etc.) may be configured to locate a particular one of the tree nodes in the B-tree data structure in about twenty or fewer searches. Conversely, the total number (N) of tree nodes to be contained in a binary B-tree data structure, with a desired height H, may be represented or determined as N=2^{H}. Then, for a B-tree data structure comprising a height of 20, the B-tree data structure may contain 2²⁰ tree nodes, or 1,048,576 tree nodes. By comparison, in a conventional data structure, to locate a particular piece of data in 1,048,576 pieces of data might require as many as one million searches, or more, to find the particular data.

With continued reference to FIG. 1, an example portion of a B-tree data structure 124 (as part of node device 114a, for example) includes an individual tree node 126 for the account ID “1234” (which are the last four digits of the consumer's payment account number used in the above transaction) (where five such tree nodes are illustrated for the data structure 124 for various different account IDs), and an example transaction array 128 (or data array) for the tree node 126 (broadly, a transaction data structure), are illustrated in FIG. 1, each of which is included in the node device 114a. It should be appreciated that the data structure 124, the tree node 126, and the array 128 are shown with only a few entries, for purposes of illustration, and that actual B-tree data structures and/or transaction arrays implemented herein would likely include a greater number of nodes and/or addresses, etc. For example, based on use of the last four digits of payment account numbers as tree nodes in the B-tree data structure 124 (as shown in FIG. 1), the total number of tree nodes included in the B-tree data structure 124 may be 3,333 (i.e., 10,000 total potential nodes divided among the three node devices 114a-c in the payment network 106 of the illustrated system 100) and the height of the B-tree data structure 124 may then be 12. Likewise, while the above is presented with respect to node device 114a, it should be appreciated that the node devices 114b-c would include similar structures, nodes and/or arrays.

As shown in FIG. 1, the example portion of the B-tree data structure 124 for the node device 114a includes five tree nodes, or entries, in which each is specific to an account. As indicated above, the consumer 112 is associated with an account, which ends in 1234. The B-tree data structure 124 includes a tree node 126, which is specific to the account ID 1234 (at the data structure 124). As shown, the tree node 126 then includes the account ID, i.e., “1234”, an interbank card association (i.e., ICA) number associated with the corresponding transaction, a product code (i.e., prod_code) (e.g., a code indicative of the product associated with the transaction, etc.), a merchant location ID (i.e., MerchantLocaitonID) (e.g., the country, city, region, or postal code of the merchant involved in the transaction, etc.), and a network transaction address listing (i.e., Trans_Address_List), etc. It should be appreciated that the data structure 124, including the particular tree node 126 for the account ID 1234, may include other account-specific data, etc. in other embodiments, such as, for example, a consumer name, a consumer address, an account type, an expiration date, a card verification code (CVC), etc.

As further shown in FIG. 1, the transaction array 128 is representative of a block of RAM memory (or random access memory) within the node device 114a. The transaction array 128 includes transaction data received and stored in “used” memory, of memory 204, for example, as designated by the “X,” and then also includes “open” memory, in which no transaction data has yet been stored, as designed by the “0.” Although exemplary transaction data is included in the illustrated transaction array 128, specifically transaction addresses, transaction amounts, merchant location IDs, merchant category codes (MCCs), and transaction types, it should be appreciated that other and/or additional transaction data may be included in other system embodiments.

In connection therewith, as additional transaction data is received in connection with the account ID 1234, the node device 114a is configured to store the additional transaction data in the transaction array 128 in the open memory of the allocated block (which is then re-designated in the block with an “X” as being “used”). The node device 114a is further configured to append, to the tree node 126, a network transaction address for each additional transaction, for the specific account, included in the transaction array 128 (in the transaction address list). Further, if the B-tree data structure 124 does not include a tree node specific to an account, for which transaction data is received, the node device 114a is configured to add a tree node, specific to the account, to the tree node data structure 124, and further to append the transaction address of the stored transaction data to the newly added tree node for the account.

With that said, it should be appreciated that the node device 114a (and also node device 114b-c) may be configured otherwise, in other embodiments, whereby the data structures included therein (e.g., the B-tree data structure 124 and its corresponding parts, etc.) are defined otherwise.

With continued reference to FIG. 1, in the exemplary embodiment, the payment network 106 of the system 100 further includes a prediction engine 120, which is configured, by computer executable instructions, for example, to perform one or more of the operations herein. For purposes of the description herein, the prediction engine 120 may be considered (or may be considered implemented in) a computing device consistent with the computing device 200 of FIG. 2. In particular, the prediction engine 120 is configured to determine a prediction score for a particular behavior, for example, for the consumer 112, in real time (or near real time), based on transactions associated with the consumer's payment account.

Specifically, the prediction engine 120 is associated with a model buffer 122, which is coupled to the prediction engine 120 and/or is in communication therewith, as indicated by the dotted lines in FIG. 1. In at least one embodiment, the model buffer 122 is incorporated into the prediction engine 120. Regardless, the model buffer 122 is populated with one or more models, which are built based on transaction data and conventional methods, and with one or more predictor variables for use in the model(s) as described herein.

When triggered, the prediction engine 120 is configured to determine and store one or more predicted variables, based on the models from the model buffer 122. More specifically, in this embodiment, when transaction data is received by the payment network 106, it is stored consistent with the description above (e.g., in one of the node devices 114a-c, etc.). This may trigger the prediction engine 120, after one transaction, or after multiple transactions or otherwise. In response (i.e., once triggered), the prediction engine 120 is configured to pull the transaction data for the given account (associated with the transaction) into the model buffer 122 and to determine a prediction score associated with a predicted variable, for example, indicating a likelihood that the predicted variable will be true or false (e.g., whether the predicted variable occurs or does not occur, etc.). That is, for example, a predicted variable may be whether the consumer 112 is going to travel in the next 30 days, and the prediction engine 120 may be configured to determine the prediction score as an indication of the likelihood the consumer 112 (associated with the given transaction) will travel in the next 30 days (e.g., a 20% likelihood, a 74.3% likelihood, etc.).

As described herein, the prediction engine 120 may be configured to determine the prediction score for the consumer 112 in real time, or in near real time. Real time, for example, may include determining the prediction score immediately after or within a few seconds of a transaction being received at the payment network 106 (e.g., within about one second, within about three seconds, within about five seconds, within about ten seconds, within about thirty seconds, within about one minute, etc.), and near real time may include determining the prediction score within a later time of the transaction being received at the payment network 106, but still within about a minute, about two minutes, about five minutes, or about 30 minutes, etc.

In addition in the system 100, the prediction engine 120 is configured to transmit and/or publish the prediction score to a marketing service, for example, associated with the payment network 106, which in turn causes various marketing efforts/offers to be directed to the consumer 112, and/or causes such marketing efforts/offers to be maintained, based on the prediction score. For example, when a prediction score for the consumer 112 to purchase a television, for example, goes from 0.4 (or 40% likely to purchase the television) to 0.62 (or 62%), the marketing service, based on rules associated therewith, may opt to provide advertisements to the consumer 112 including, for example, providing an incentive to the consumer 112 for a television. It should be appreciated that the prediction score may relate to a variety of different marketing services for a variety of different products, and/or may further relate to other services unrelated to marketing within the scope of the present disclosure.

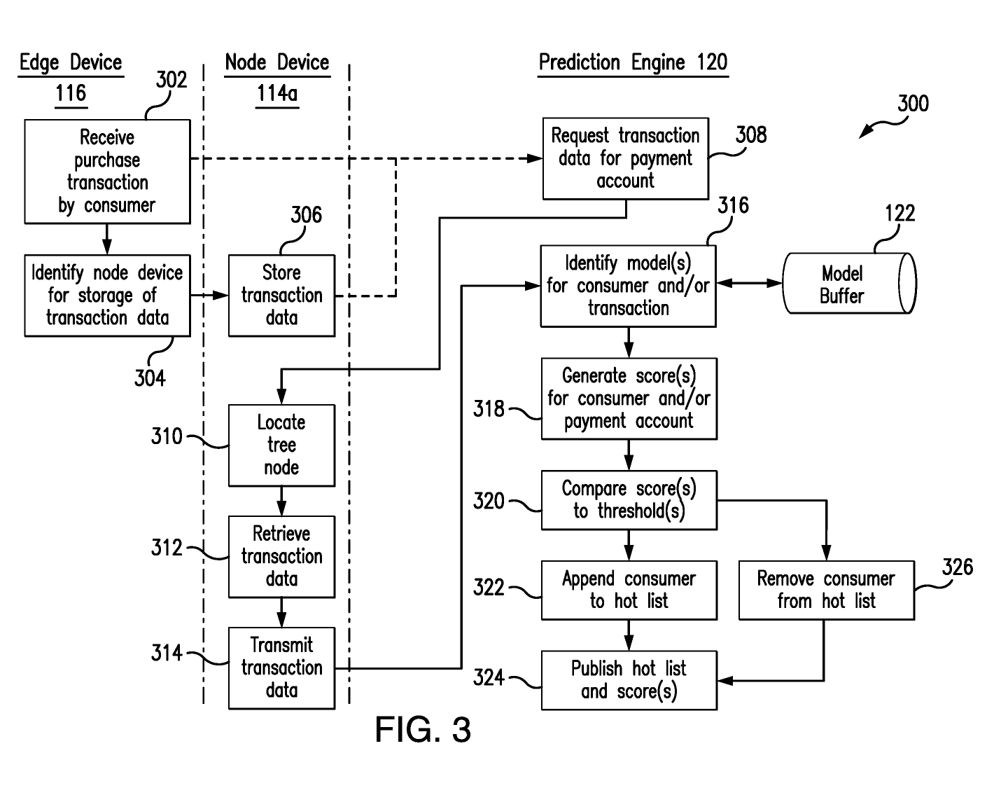

FIG. 3 illustrates an exemplary method 300 for use in distributing account data (e.g., transaction data, etc.) to particular nodes of a payment network to permit real time, or near real time, scoring of the data. The exemplary method 300 is described with reference to the system 100 (e.g., as implemented in the prediction engine 120, etc.) and the computing device 200. Nonetheless, it should be appreciated that the methods herein are not limited to the exemplary system 100 or the exemplary computing device 200 and, similarly, that the systems and computing devices herein are not limited to the exemplary method 300.

In the method 300, when the consumer 112 initiates a transaction to his/her payment account at the merchant 102, for example, transaction data is provided to the payment network 106 from the acquirer 104 (e.g., via an authorization request for the transaction, etc.) and/or from the issuer 108 (e.g., via an authorization reply for the transaction, etc.). At 302, the transaction data for the newly initiated transaction is received by the payment network 106, and in particular, by edge device 116. Thereafter, the edge device 116 identifies the one of the node devices 114a-c into which the transaction data will be stored, at 304. Specifically, for example, each of the node devices 114a-c of the payment network 106, and any additional node devices thereof (not shown), are assigned a residual or remainder (as generally described above in the system 100). For example, for 57 node devices, each of the node devices is assigned a residual ranging from 0 to 56. Then, in order for the edge device 116 to identify the desired node device for a given transaction, the edge device 116 divides the account number included in the transaction data by 57, which will leave a residual or remainder of 0-56. The edge device 116 then identifies the node device to which the transaction data is to be stored by the residual. So in the illustrated embodiment of FIG. 1, where there are 3 node devices (including the node devices 114a-c) and where the last four digits of the consumer's account number is 1234, dividing 1234 by 3 yields a residual of 1 (i.e., 1234=(411*3)+1). In this exemplary embodiment, the node device 114a, for example, is designated for a residual of 1, whereby the edge device 116 identifies the node device 114a to store the transaction data for the account number 1234. It should be appreciated that, by identifying the node device in the above manner, the same node device will be identified for all transaction data related to one account (i.e., the residual will always be the same), whereby all transaction data for an account will be stored in one node device. That said, it should be appreciated that other operations may be employed by the edge device 116 in other method embodiments to repeat-ably identify the node device (e.g., node device 114a, etc.) for a given account (e.g., for the account ending in 1234, etc.).

Once the particular node device 114a is identified, the transaction data is provided to the node device 114a and, at 306, is stored in the node device 114a. Specifically, in this exemplary embodiment, the node device 114a stores the transaction data in the transaction array 128 in memory 204, and specifically, in RAM memory, with each transaction being associated with a particular transaction address. In general, the node device 114a stores the transaction data in a next available transaction address, whereby the transaction address is then transitioned from open (designated as “0” in the transaction array 128) to used (designated as “X” in the transaction array 128). The node device 114a further utilizes the B-tree data structure 124 to identify the tree node 126 associated with the payment account for the consumer 112, and then appends the transaction address of the transaction data for the payment account of the consumer 112 to the transaction address list in the tree node 126. It should be appreciated that the node device 114a may store the transaction data in memory (e.g., memory 204) therein in a variety of different manners.

In this exemplary embodiment, the new transaction initiated by the consumer 112 and/or the corresponding storing of new transaction data associated with the transaction within the node device 114a is a trigger event, which causes the prediction engine 120 to operate as described below. With that said, however, other trigger events may also be realized by the prediction engine 120. For example, a trigger event may include a transaction of a certain type and/or within a certain category. Where, for example, the prediction score to be determined by the prediction engine 120 relates to travel, the trigger event may include a transaction by the consumer 112 having the MCC 4722 (Travel Agencies and Tour Operators). Other content of the transaction may also (or alternatively) cause the transaction to be a trigger event, while other transactions are not. In addition, the number of transactions, in general, or per interval, may provide a trigger event. For example, five transactions may trigger the prediction engine 120, or eight transactions within about 20 minutes may also trigger the prediction engine 120. It should be appreciated that various aspects of a given transaction and/or of multiple transactions (or numbers thereof) involving the consumer's payment account may trigger the prediction engine 120 to operate as described herein, in real time or in near real time thereafter. In at least one embodiment, the trigger event is unrelated to a transaction at the payment account (e.g., is related to an altered threshold, model, time, etc.).

In any case, in response to the trigger event in this example (as indicated by the dotted lines in FIG. 3 (e.g., based on notification by the edge device 116 and/or the node device 114a, etc.)), the prediction engine 120 retrieves (e.g., requests, etc.) the transaction data, for the consumer's payment account, from the node device 114a, at 308 (e.g., relating to the consumer's account 1234, etc.). In particular, for example, upon request by the prediction engine 120, the node device 114a accesses the B-tree data structure 124 to search for the account 1234 (and the particular tree node 126 associated therewith), at 310. The time (e.g., the total number of potentially required searches, etc.) to search the B-tree data structure 124, then, is log₂ N, where N represents the total number of tree nodes included in the B-tree data structure 124. As such, based on use of the B-tree data structure 124, and the data structure 124 potentially including 3,333 total tree nodes (i.e., 10,000 potential unique numbers based on the last four digits of the account numbers, divided by the three node devices 114a-c), the node device 114a may be able, in this exemplary embodiment, to identify a desired one of the tree nodes (e.g., the tree node 126, etc.) in about twelve searches (i.e., log₂ 3333=11.702) or less. As indicated above (and as just discussed for this exemplary embodiment), this use of the B-tree data structure 124 in the node device 114a may improve search efficiencies to locate the desired tree node 126 and thereby facilitate the real time (or near real time) features (e.g., scoring, etc.) described herein.

After the desired tree node 126 is located at the B-tree data structure 124, the node device 114a accesses the memory (e.g., the memory 204, etc.), and specifically the RAM therein, and retrieves, at 312, the transaction data for the consumer 112 based on the transaction address list included in the tree node 126, as referenced in the transaction array 128, in RAM memory. By use of RAM memory, in this exemplary embodiment, the node device 114b may be able to read/write data to the B-tree data structure 124 substantially faster than for other types of memory (e.g., RAM may provide read/write capabilities in the range of about 20 G/sec, while mechanical hard disks may provide read/write capabilities in the range of about 20 M/sec and solid state drives (SSDs) may provide read/write capabilities in the range of about 100 M/sec; etc.) (depending on particular hardware configurations, etc.). The node device 114a then transmits, at 314, the retrieved transaction data to the prediction engine 120. In this manner, the prediction engine 120 generally receives the transaction data in real time (or near real) time, in connection with performance of the underlying transaction, thereby further facilitating the real time (or near real time) features (e.g., scoring, etc.) described herein.

It should be appreciated that all transaction data for the consumer's account may be retrieved (including transaction data for the most recent transaction relating to the trigger event) and transmitted to the prediction engine 120, or only a part of the transaction data may be retrieved (e.g., based on time interval, transaction data content (e.g., MCC, transaction type, etc.)), and/or based on other aspects of the transaction data or otherwise, in other embodiments.

In addition, in various embodiments, in response to the trigger event (e.g., in response to storing the transaction data, at 306, for the given transaction, etc.), the node device 114a may instead locate the tree node 126 (at 310), retrieve the transaction data for the given transaction (at 312), and transmit the retrieved transaction data to the prediction engine 120 (at 314) without a particular request from the prediction engine 120. In so doing, the node device 114a may also notify the prediction engine 120 of the purchase transaction by the consumer 112 (if the prediction engine is not otherwise notified, for example, by the edge device 116, etc.) (broadly, the node device 114a may notify (e.g., transmit a notification, etc.) the prediction engine 120 of the trigger event). Again, in this manner, the prediction engine 120 generally receives the transaction data in real time (or near real) time, in connection with performance of the underlying transaction, thereby further facilitating the real time (or near real time) features (e.g., scoring, etc.) described herein.

Next in the method 300, once the transaction data is returned to the prediction engine 120, it is stored in the model buffer 122 (e.g., by the prediction engine 120, etc.). Thereafter, the prediction engine 120 identifies, at 316, a model (or multiple models) to be used to generate one or more prediction scores for the consumer 112 (in response to the given trigger event) and/or for the new transaction at the merchant 102, from the model buffer 122. The models, in general, are built based on patterns identified in historical transaction data for the consumer's payment account and/or for multiple payment accounts in general (e.g., taking into account machine learning modeling, statistical modeling, etc.), which are related or unrelated to the consumer 112 (e.g., based on demographics, location, etc.). For example, in response to a trigger event for the consumer 112, the prediction engine 120 may identify one or more models that rely on a total spend and/or a frequency of the consumer's prior transactions at particular merchants (or merchant types, for example, based on MCCs, etc.) (e.g., a shoe store merchant, a restaurant merchant, etc.) to generate propensity model scores for the consumer 112. The propensity model scores may, for example, indicate that if the consumer's transaction data includes one purchase in the last month (and/or a total spend of less than $150 in the last month) in a given category then more purchases are forthcoming in the category. Additionally, or alternatively, the models may, for example, indicate that if the consumer's transaction data indicates three or more purchases in the last month (and/or a total spend of more than $150 in the last month) in a given category then no further purchases are likely in the category in the next 30 days. Also, in response to the trigger event (or in response to another trigger event), a model may be used to generate a propensity model score specifying, for example, that when the transition data for the consumer 112 identifies travel by the consumer 112 in the last 30 days in a specific region (e.g., the United Kingdom, or Mexico, etc.), the consumer 112 may (or may not) further travel in the same region in the next 60 days.

In general, the models used by (and/or available to) the prediction engine 120 are pre-developed machine learning models, statistical models, etc. based on market demand, and are maintained in the model buffer 122 (e.g., statistical models may be generated based on historical transaction data for multiple different consumers as a sample in the past by setting a snapshot time, where prior to the snapshot time the information of each consumer is collected as a predictor; etc.). As such, the models are available to the prediction engine 120 for generating the propensity model scores in real time (or near real time). As can be appreciated, dynamic aspects of consumer demand may rely specifically and/or heavily on recent purchase events. For example, if the consumer 112 just purchased shoes five minutes ago, the demand for shoes by the consumer 112 in the next few weeks or months will drop to almost zero. Capturing such consumer dynamic demand is one aspect of the disclosure and is generally dependent on the efficiencies of searching as described herein (e.g., through use of B-tree data structures, etc.). With that said, multiple variables may be used to capture such demand. Table 1 illustrates example variables that may be utilized in one or more models to capture such demand in connection with a grocery merchant (although it should be appreciated that similar variables may be applied to models relating to other merchant categories). In addition, other variables that may be used may include, for example, product SKU codes, times/dates of the transactions, merchant names and/or locations, payment types and/or channels, etc.

TABLE 1

| Variable | Variable | |
|---|---|---|
| ID | Name | Variable Label |
| 12345 | V_12345 | Grocery: Days since last visit |
| 12346 | V_12346 | Grocery: Average days between visit |
| 12347 | V_12347 | Grocery: Average AMT |
| 12348 | V_12348 | Grocery: Last AMT |
| 12349 | V_12349 | Grocery-Drink: Days since last purchase |
| 12350 | V_12350 | Grocery-Drink: Average days between purchases |
| 12351 | V_12351 | Grocery-Drink: Average AMT |
| 12352 | V_12352 | Grocery-Drink: Last AMT |
| 12353 | V_12353 | Grocery-Vegi: Days since last purchase |
| 12354 | V_12354 | Grocery-Vegi: Average days between purchases |
| 12355 | V_12355 | Grocery-Vegi: Average AMT |
| 12356 | V_12356 | Grocery-Vegi: Last AMT |
| 12357 | V_12357 | Grocery-Meat: Days since last purchase |
| 12358 | V_12358 | Grocery-Meat: Average days between purchases |
| 12359 | V_12359 | Grocery-Meat: Average AMT |
| 12360 | V_12360 | Grocery-Meat: Last AMT |
| 12361 | V_12361 | Grocery-Dairy: Days since last purchase |
| 12362 | V_12362 | Grocery-Dairy: Average days between purchases |
| 12363 | V_12363 | Grocery-Dairy: Average AMT |
| 12364 | V_12364 | Grocery-Dairy: Last AMT |
| . . . | . . . | . . . |

As an example, a model may be constructed for predicting whether or not the consumer 112 will travel to the United Kingdom in the next three months, based on a specific date, for example, January 1, by which to calculate the three month period. In connection therewith, the model may include a linear equation, such as Equation (1), which is constructed based on prior historical transactions by the consumer 112 and/or by one or more other consumers. The output of Equation (1), L, may then be applied to a logistic regression, such as Equation (2), to determine the propensity model score (in a range of 0 to 1) for the consumer 112 to travel to the United Kingdom in the next three months. In Equation (1), X₁ represents a number of times the consumer 112 traveled to Europe in the last two years, X₂ represents a number of times the consumer 112 traveled to the United Kingdom in the last three months, and X₃ represents a number of times the consumer 112 purchases travel to Asia in the last week (based on retrieved transaction data for the consumer 112). It should be appreciated that the variables X₁, X₂, and X₃ may be weighted as desired, for example, based on prior transaction data for the consumer 112 and/or for other consumers, etc. It should also be appreciated, again, that multiple additional (or different) variables may be included in other embodiments (e.g., based on the consumers' prior transaction data, based on the application of the model, etc.).

$$\begin{matrix}L = - 0.5 + 0.3 {X}_{1} - 0.5 {X}_{2} - 0.2 {X}_{3} & ( 1 ) \\ P = \frac{1}{1 + {e}^{L}} & ( 2 )\end{matrix}$$

In connection therewith, Equation (1) and Equation (2) may be used to generate the propensity model score for the consumer 112 for Travel to the United Kingdom as follows. Upon retrieving the consumer's transaction data, the corresponding transactions may indicate that the consumer 112 traveled to Europe seven times in the last two years and traveled to the UK twice in the last three months, but has not traveled to Asia in the last week. As such, in this example where Equation (1) includes the three variables X₁, X₂, and X₃, the output, L, of Equation (1) is 0.6 (i.e., −0.5+0.3(7)−0.5(2)−0.2(0)). And, the propensity model score, P, from Equation (2) is 0.35 (i.e., 1/(1+e^{0.6})). It should be appreciated that Equation (1) and Equation (2) may similarly be used as a general basis to generate other propensity model scores, for example, for the travel to other locations such as Japan, etc.; for future purchases of shoes, food at restaurants, etc.; etc. (but using different variables and/or different weights based on the particular model and/or available transaction data, etc.).

Then in the method 300, once the desired prediction score(s) is/are generated based on the identified model(s), the prediction engine 120 compares, at 320, the generated scores to one or more thresholds. Table 2 illustrates various example propensity model scores that may be generated for the consumer 112, based on his/her retrieved transaction data, in response to a given trigger event. As shown, the propensity model scores relate to transactions by the consumer 112 for travel to the United Kingdom (UK) and to Japan, and to transactions by the consumer 112 for shoes and at restaurants. Table 2 also illustrates example predefined thresholds (or benchmarks) that may be used by the prediction engine 120 (e.g., based on prior modeling of historical transaction data taking into account multiple variables, etc.) as a basis to determine whether future purchases will be made by the consumer 112 in the same or similar merchant categories (i.e., when the propensity model score passes the given benchmark cut-off), or not.

TABLE 2
Account ID: 1234

| | Propensity | Benchmark | |
|---|---|---|---|
| Model | Model Score | Cut-Off | Pass |
| Travel to UK | 0.35 | 0.1 | Yes |
| Travel to Japan | 0.1 | 0.05 | Yes |
| Purchase Shoes | 0.2 | 0.25 | No |
| Restaurant | 0.3 | 0.5 | No |
| . . . | . . . | . . . | . . . |

In turn, depending on whether the given score satisfies the corresponding threshold, the prediction engine 120 appends, at 322, the consumer 112 and/or the consumer's payment account to a “hot list” (or hot list data structure) for one or more particular services to which the model(s) is/are related. The hot list may relate to transactions only by the consumer 112, in multiple different categories. Or, the hot list may relate to transactions by multiple different consumers (including the consumer 112) in on or more common categories. In the above example, the consumer 112 is appended to a hot list for marketing related to certain tool-related merchants (based on the prediction score for the consumer 112), since the consumer's total spend in the MCC 7394 exceeds the $150 threshold included in the model. The prediction engine 120 then publishes, at 324, the hot list (together with the generated prediction score(s)) to one or more entities associated with services related to the hot list (e.g., to a public marketing exchange board, etc. whereby the predicted probability scores for different consumers can be ranked and the top ranked customers may be selected for particular marketing efforts; etc.). So, for example, a hot list related to MCC 7394 may include entities (e.g., merchants, etc.) that provide tool rental equipment or tools for sale (e.g., home centers, etc.) to consumers. In response to the hot list, the entities are able to direct marketing to the consumer 112. Again, this may be done for the particular consumer 112, or it may be done for multiple consumers based on the particular model used to generate the propensity model score (e.g., as shown in Table 3, etc.). This may also be done for particular models, including those in Table 3, as well as for any other desired models.

TABLE 3

| Model | Account ID | Date Updated |
|---|---|---|
| Travel to UK | 1234 | January 1 |
| | 2233 | January 2 |
| | 1234 | January 15 |
| | . . . | . . . |
| Travel to Japan | 1234 | January 15 |
| | . . . | . . . |

It should be appreciated that services associated with the hot list will then gain access to the consumer 112, and in particular, a consumer contact data structure (not shown) whereby the prediction engine 120 and/or certain entities will be able to contact the consumer 112. In doing so, the prediction engine 120 and/or the different entities may deliver promotions from a market promotion data structure (not shown), which may be associated with still a variety of other entities.

What's more, when the consumer 112 is appended to the hot list (or is otherwise scored and not appended to the hot list), another trigger event may cause the prediction engine 120 to re-generate and/or update the prediction score(s) of the consumer 112, at 318 (broadly, repeat operations 318-324). Such subsequent trigger may include another transaction by the consumer 112, or it may include a temporal trigger (where the prediction score(s) is/are updated after a defined interval (e.g., an hour, a number of hours, days, weeks, an interval based at least in part on the particular model from which the prediction score is generated, etc.). In this manner, if the consumer is not yet appended to the hot list, the consumer 112 may later be added to the hot list (at 322) when the regenerated predication score(s) satisfy the corresponding threshold(s), at 320. Alternatively, when the consumer 112 is appended to the hot list and the comparison, at 320, indicates that the regenerated score(s) fail to satisfy the corresponding threshold(s), the consumer 112 may be removed from the hot list, at 326. The updated hot list may then be republished, at 324.

Additionally in the method 300, or alternatively, after generating the prediction score, at 318, the prediction engine 120 may transmit the score to the edge device 116, which in turn provides (or otherwise exposes) the score to an entity associated with the consumer's payment account, such as, for example, the issuer 108, or others that may desire to use such data for marketing purposes, etc. (e.g., upon request by the entity, up a subscription to such a service by the entity, etc.). This may be done as part of publishing the hot list, at 324. As an example, the output to the issuer 108 may include a data structure comprising the consumer's account number (or representation thereof), score data for the consumer (and/or the consumer's payment account), and then multiple scores for the consumer 112. The entities receiving the output may then utilize the information (e.g., the scores, the number of days since the scores have been updated, etc.) in various services associated with, for example, marketing, coupons, fraud prevention, etc.

Table 4 illustrates an exemplary data structure comprising prediction scores for the consumer 112 (where the consumer 112 has been appended to a hot list, at 316 in the method 300), as generated by the prediction engine 120 for five different transactions, and various corresponding information relating thereto. In particular, the exemplary data structure includes, for each of the given transactions, a representation of the consumer's payment account (i.e., a Masked Account ID), a region of the transaction, a thereof), a target category for the transaction (e.g., taking into account MCC, etc.), a detail for the transaction (e.g., particular products purchased, etc.), a type of the transaction, a prediction score associated with the transaction, and a duration since the score was last calculated.

TABLE 4

| Masked | | | | | | Number |
|---|---|---|---|---|---|---|
| Account | | Target | | | | days since |
| ID | Region | Category | Detail | Type | Score | updated |
| 35 | US | Travel | UK | Air | 0.35 | 0.5 |
| 35 | US | Apparel | Clothing | Local | 0.5 | 3 |
| 35 | US | Eating | Indian | Local | 0.3 | 3 |
| | | Place | Food | | | |
| 35 | US | Apparel | Shoe | Online | 0.2 | 0.5 |
| 35 | US | Grocery | Food | Local | 0.7 | 7 |

When the exemplary data structure of Table 4 is exposed (or otherwise published) and thereby made available by the edge device 116 to an airline company, for example (as part of a service provided by the payment network 106 to the airline company, etc.), the airline company may then search the data structure for transactions related to travel. In so doing, the airline company may see that the consumer 112 (as a member of a hot list) has relatively high prediction scores relating to booking travel from the US to UK. In response, the airline company may then direct one or more marketing offers to the consumer 112 relating to travel.

In various embodiments, the data structure of Table 4 may be combined with other similar data structures for other consumers (that have been appended to a hot list, at 316 in the method 300, for example) and provided together (as a single data structure) to one or more particular entities. The entity may then target particular ones of the consumers that have relatively high prediction scores in areas relating to their given business. With that said, it should be appreciated that the format of the output may be otherwise in other embodiments (e.g., other than illustrated in Table 4, etc.), yet still include certain information to be conveyed to the issuer 108 and/or other entities.

In connection therewith, in one example, the airline company from the above example may provide marketing instructions for consumers on the hot list. Specifically, as shown in Table 5, for the specific model relating to travel to the UK, the airline company may specify that when the consumer 112 is included in the hot list, and it has been less than two days since the propensity model score for the given model has been updated, that advertisements are to be transmitted to the consumer 112 online via a URL link. It should be appreciated that similar (or different) marketing instructions may be implemented by other merchants and/or for other models within the scope of the present disclosure.

TABLE 5
Marketing Instruction

| | |
|---|---|
| Model | Travel to UK |
| Days updated | <=2 |
| Marketing material | URL link |
| Channel | Online |

In view of the above, the systems and methods herein provide distribution of account data to particular node devices to permit real time scoring of consumers and/or payment accounts for one or more services (e.g., marketing services, fraud protection services, reporting services, etc.). In particular, transaction data may be accessible, in RAM memory, at one node device, more efficiently and more rapidly than in other types of memory, such as, for example, disk memory. Further, the transaction data of a particular set (e.g., related to a particular payment account, etc.) may be stored in one particular node device (e.g., consolidated in one particular node device, etc.), and not spread over multiple different node devices, thereby potentially enabling more efficient retrieval of the data set and/or independent operations of the node device in storing the transaction data. Further, use of the B-tree methodology, in certain embodiments, permits the search for the payment account and, specifically, transaction data associated with the payment account to be accomplished in an efficient and unconventional manner.

Further, conventional scoring systems are typically designed as batch sequential processes that score massive numbers of accounts in one-time data pass processes. As can be appreciated, this may be efficient for massive, generic marketing campaigns. However, such massive campaigns are often based on old transaction data and do not reflect recent purchases, trends, desires, etc. For example, a conventional scoring system may determine that a consumer has a high propensity to book a ticket to the United Kingdom in the next month, based on a score processed two or three weeks ago. However, if the consumer recently purchases an airline ticket to Asia (e.g., within the last day, etc.), his/her propensity to travel to the United Kingdom within the remaining week is dramatically reduced. Conventional scoring systems generally are not able to modify the consumer's propensity to travel to the United Kingdom (in real time or near real time) based this recent transaction. The systems and methods herein, however, account for such transactions. In connection therewith, in order to have timely access to the consumer's account and recent transactions (and in order to allow for such updates), the systems and methods herein rely specifically on the B-Tree data structure described herein (and further may rely on other similar structures to gain similar efficiencies in other embodiments).

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of: (a) locating, in response to a trigger event, a tree node for a payment account in a B-tree data structure, the tree node including at least one transaction address in a transaction array; (b) retrieving transaction data associated with the at least one transaction address from the transaction array; (c) transmitting the transaction data to at least one computing device; and (d) generating and publishing, at the at least one computing device, at least one score based on a historical model and the retrieved transaction data in real time or near real time, thereby permitting services based on the at least one score to be offered to a consumer associated with the payment account.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “connected to,” “coupled to,” or “in communication with” another feature, it may be directly on, connected or coupled to, or in communication with the other feature, or intervening features may be present. In contrast, when a feature is referred to as being “directly on,” “directly connected to,” “directly coupled to,” or “directly in communication with” another feature, there may be no intervening features present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for use in distributing network transaction data in a network, the system comprising:
an edge device for receiving network transaction data associated with an account from at least one partner associated with the network; and
multiple node devices in communication with the edge device, each of the multiple node devices including a B-tree data structure capable of storing network transaction data;
wherein the edge device is configured to:
identify one of the multiple node devices for storing the received network transaction data based on the account associated with the network transaction data; and
transmit the received network transaction data to the identified one of the multiple node devices; and
wherein the identified one of the multiple node devices is configured to:
receive the network transaction data from the edge device;
identify a tree node in the B-tree data structure of the identified one of the multiple node devices, the identified tree node associated with the account;
append the network transaction data to a next entry in a data array of the B-tree data structure, the next entry associated with a network transaction address; and
append the network transaction address to the identified tree node.

2. The system of claim 1, wherein the identified one of the multiple node devices is further configured, in response to a request for network transaction data for the account, to:
identify the tree node of the B-tree data structure, of the identified one of the multiple node devices, associated with the account, the tree node including the network transaction address for the next entry to which the received network transaction data is appended and multiple other network transaction addresses;
retrieve the network transaction data for the account, as identified in the request, from the data array of the B-tree data structure based on the network transaction address for the network transaction data; and
transmit the network transaction data to a prediction engine.

3. The system of claim 2, further comprising the prediction engine in communication with the identified one of the multiple node devices, the prediction engine configured to:
generate a score for a consumer associated with the account based on the network transaction data transmitted to the prediction engine;
append the consumer to a hot list when the generated score satisfies at least one threshold; and
publish the hot list after appending the consumer to the hot list.

4. The system of claim 1, wherein each of the multiple node devices includes random access memory (RAM); and
wherein the data array of the B-tree data structure is stored in the RAM of the identified one of the multiple node devices.

5. The system of claim 4, wherein the data array of the B-tree data structure, of the identified one of the multiple node devices, includes a series of network transaction addresses including the network transaction address for the next entry in the data array; and
wherein each of the network transaction addresses prior to the network transaction address for the next entry includes network transaction data, and wherein each of the network transaction addresses after the network transaction address for the next entry is open and reserved for network transaction data associated with the account.

6. A computer-implemented method for use in scoring of transaction data related to a payment account, the method comprising:
locating, by a node device, in response to a trigger event, a tree node for a payment account in a B-tree data structure, the tree node including at least one transaction address in a transaction array;
retrieving, by the node device, transaction data associated with the at least one transaction address from the transaction array;
transmitting, by the node device, the transaction data to at least one computing device; and
generating and publishing, at the at least one computing device, at least one score based on a historical model and the retrieved transaction data in real time or near real time, thereby permitting services based on the at least one score to be offered to a consumer associated with the payment account.

7. The computer-implemented method of claim 6, wherein retrieving the transaction data associated with the at least one transaction address includes retrieving the transaction data from the transaction array stored in random access memory (RAM).

8. The computer-implemented method of claim 6, wherein the trigger event includes a transaction to the payment account, the transaction data associated with the transaction.

9. The computer-implemented method of claim 8, further comprising storing, by the node device, the transaction data associated with the transaction in the transaction array in association with the at least one transaction address.

10. The computer-implemented method of claim 9, further comprising transmitting, by the node device, a notification of the trigger event to the at least one computing device prior to or together with transmitting the transaction data.

11. The computer-implemented method of claim 8, further comprising comparing the generated score to at least one defined threshold, and when the generated score satisfies the at least one defined threshold, appending the consumer and the generated score to a hot list data structure; and
wherein the consumer is associated with a masked account identifier in the hot list data structure.

12. The computer-implemented method of claim 11, wherein publishing the at least one score includes publishing the at least one score when the generated score satisfies the at least one defined threshold.

13. The computer-implemented method of claim 11, further comprising:
updating the at least one score after a defined interval;
removing the consumer from the hot list data structure when the update of the at least one score fails to satisfy the defined threshold; and
publishing the hot list data structure after removing the consumer from the hot list data structure.

14. The computer-implemented method of claim 11, further comprising:
updating the at least one score after a defined interval; and
appending the consumer to the hot list data structure when the update of the at least one score satisfies the defined threshold; and
publishing the hot list data structure.

15. The computer-implemented method of claim 6, further comprising:
updating the at least one score; and
publishing the update of the at least one score, thereby permitting services based on the update of the at least one score to be offered to the consumer associated with the payment account.

16. A non-transitory computer readable storage media including executable instructions for use in scoring network transaction data related to an account, which, when executed by at least one processor, cause the at least one processor to:
locate, in response to a transaction to an account, a tree node for the account in a data structure, the tree node including at least one network transaction address in a data array;
retrieve network transaction data associated with the at least one network transaction address from the data array; and
generate at least one score based on a historical model and the retrieved transaction data in real time or near real time, thereby permitting services based on the at least one score to be offered to a consumer associated with the payment account.

17. The non-transitory computer readable storage media of claim 16, wherein the tree node includes a B-tree data structure associated with the data array; and
wherein the executable instructions, when executed by the at least one processor in connection with retrieving the network transaction data associated with the at least one network transaction address, cause the at least one processor to retrieve the network transaction data from the data array stored in random access memory (RAM).

18. The computer-implemented method of claim 16, wherein the executable instructions, when executed by the at least one processor, further cause the at least one processor to:
compare the generated at least one score to at least one defined threshold; and
when the generated score satisfies the at least one defined threshold, append the consumer and the generated score to a hot list data structure.

19. The computer-implemented method of claim 18, wherein the executable instructions, when executed by the at least one processor, further cause the at least one processor to publish the at least one score when the at least one score satisfies the at least one defined threshold.

20. The computer-implemented method of claim 18, wherein the executable instructions, when executed by the at least one processor, further cause the at least one processor to:
update the at least one score;
remove the consumer from the hot list data structure when the update of the at least one score fails to satisfy the defined threshold; and
publish the hot list data structure after removing the consumer from the hot list data structure, thereby permitting services based on the update of the at least one score to be offered to the consumer associated with the payment account.
